(19) United States
(12) Patent Application Publication
(10) Pub. No.: US 2025/0239845 A1
(43) Pub. Date: Jul. 24, 2025

(54) Improvements to a Cable Drum

(71) Applicant: AFIK GROUP P.K LTD., AVIGDOR (IL)

(72) Inventor: Arieh FRANK, AVIGDOR (IL)

(73) Assignee: AFIK GROUP P.K LTD., AVIGDOR (IL)

(21) Appl. No.: 18/702,191

(22) PCT Filed: Oct. 20, 2022
(86) PCT No.: PCT/IL2022/051110

§ 371 Date: Apr. 17, 2024

Related U.S. Application Data
(60) Provisional application No. 63/270,217, filed on Oct. 21, 2021.

(51) Int. Cl. H02G 11/02

(52) U.S. Cl. CPC H02G 11/02

(57) ABSTRACT

An extension cable reel comprising a central body with an axle extending both directions from the central body. Freely rotatably mounted on the axle are at least two drums, at least one on each side of the central body. Each drum comprises a length of cable (for electrical or data connection) or hose (for fluid connection), the cable or hose reversibly windable around the drum. Each cable or hose on a first side of the central body is in electrical or fluid communication with at least one cable or hose on the second side of the central body. Each cable on the first side has a plug at its free end and each cable on the second side has at least one socket at its free end. Each hose has at least one fluid connection at its free end.

### FIELD OF THE INVENTION

The present invention generally pertains to a system and method for providing an extension cable reel with a plurality of drums, each drum carrying a length of electrical cable. The electrical cables on the plurality of drums are in electrical communication with each other so that power can be communicated from a free end of one cable to a free end of a second cable.

### BACKGROUND OF THE INVENTION

Extension cable reels in common use typically comprise a power cable rolled on a drum. One end of the power cable (the free end) is connectable to an electrical power outlet and the other end is connected to one or more power outlets on an outside face of the drum. According to European standard IEC 61242:1995/AMD2:2015, for a single-phase, 220 V, 110A power cable, the power cable length can be no more than 50 m.

Extension cable reels often also comprise other accessories, such as a circuit breaker.

In use, the plug of the cable is connected to an electrical outlet. The cable is pulled from the drum until the drum is close to the location where the user will be working. At this point, either the tool can be connected to a power outlet on the drum, or another extension cord can be connected to a power outlet on the drum, with the tool connected to the second extension cord. Since modern tools tend to have very short electrical cords (typically about 1.5 m), use of a secondary extension cable plugged into the extension cable reel is quite common. This means that the user must carry the extension cable reel and the extra extension cord as well as the tools when proceeding to the place of work, which is an awkward procedure, or make two trips, which is time-wasting. In addition, since the additional extension cord is not on a reel, it is easily tangled and can be a nuisance both to unroll it for deployment and to roll it up tidily when it is desired to put it away.

It is therefore a long felt need to provide an extension cable reel that allows a reasonable working distance, does not require a secondary extension cord to allow working at a distance from the reel, is not difficult to coil and uncoil, and which need not lie loose, and therefore be easily tangled, in use.

### SUMMARY OF THE INVENTION

It is an object of the present invention to disclose a system for providing an extension cable reel with a plurality of drums, each drum carrying a length of electrical cable. Each electrical cable is in electrical communication at all times with an electrical cable on at least one other drum so that power can be communicated from a free end of one cable to a free end of a second cable. Electrical communication does not depend on whether a drum is stationary or rotating, nor does it depend on whether a cable is laid out or is coiled around a drum.

It is another object of the present invention to disclose an extension cable reel comprising:
a central body (1) having a first face on a first side of said central body (1) and a second face on a second side of said central body (1), said second face being on an opposite side of said central body (1) from said first face; and
a first predetermined length of electrical cable (6) in electrical communication with at least one second predetermined length of electrical cable (6) via said central body (1);
wherein
   said central body (1) has an axle (11) extending perpendicular to a main plane of said central body (1), said axle (11) extending outward from said first face of said central body (1) and extending outward from said second face of said central body (1);
   a first drum (2A, 2B), freely rotatably mounted on said axle (11) on said first side, said first drum (2A, 2B) having a first drum internal face (2B) adjacent to said first face of said central body (1) and a first drum external face (2A) opposite to said first drum internal face (2B);
   a second drum (2A, 2B), freely rotatably mounted on said axle (11) on said second side, said second drum (2A, 2B) having a second drum internal face (2B) adjacent to said second face and a second drum external face (2A) opposite to said second drum internal face (2B); said at least one first predetermined length of electrical cable (6) having a first proximal end attached to said first drum (2A, 2B) and a first distal end in electrical communication with at least one plug (5), said first proximal end in electrical communication with said central body (1), said at least one first predetermined length of electrical cable (6) being reversibly windable on said first drum; and
   said at least one second predetermined length of electrical cable (6) having a second proximal end attached to said second drum (2A, 2B) and a second distal end in electrical communication with at least one electrical socket (4), said second proximal end in electrical communication with said central body (1), said at least one second predetermined length of electrical cable (6) being reversibly windable on said second drum.

It is another object of the present invention to disclose the extension cable reel as described above, wherein each current-conducting wire of said at least one first predetermined length of electrical cable (6) is in electrical communication with a current conducting wire of said at least one second predetermined length of electrical cable (6) via at least one first slip ring (13, 14, 15) on said first drum (2A, 2B) and at least one second slip ring (13, 14, 15) on said second drum (2A, 2B), each of said at least one first slip ring (13, 14, 15) and said at least one second slip ring (13, 14, 15) in electrical communication via at least one two-way contact spring (12).

It is another object of the present invention to disclose the extension cable reel as described above, wherein said central body (1) comprises a supporting member selected from a group consisting of a leg, a carrying handle, a mounting bracket and any combination thereof.

It is another object of the present invention to disclose the extension cable reel as described above, additionally comprising a member of a group consisting of a first non-rotating external face (20), a second non-rotating external face (20) and any combination thereof, said first non-rotating external face (20) being in mechanical communication with said central body (1) on said first side and said second non-rotating external face (20) being in mechanical communication with said central body (1) on said second side.

It is another object of the present invention to disclose the extension cable reel as described above, additionally comprising an accessory selected from a group consisting of an electrical socket (4), a lithium battery charging socket (17), a 5V USB battery charging socket (10), a charging socket for other rechargeable batteries, a reset switch (9), a winding handle (3), a power-on light (16) and any combination thereof.

It is another object of the present invention to disclose the extension cable reel as described above, wherein said accessory is in mechanical communication with a member of a group consisting of said first drum external face (2A), said second drum external face (2A), said first non-rotating external face (20) and said second non-rotating external face (20).

It is another object of the present invention to disclose the extension cable reel as described above, wherein at least one of a group consisting of said first drum (2A, 2B) and said second drum (2A, 2B) comprises a cable end holder (7).

It is another object of the present invention to disclose the extension cable reel as described above, wherein at least one of a group consisting of said first drum (2A, 2B) and said second drum (2A, 2B) comprises a cable rewinding mechanism.

It is another object of the present invention to disclose the extension cable reel as described above, wherein said cable rewinding mechanism comprises at least one spring.

It is another object of the present invention to disclose the extension cable reel as described above, additionally comprising at least one cable rewind stop.

It is another object of the present invention to disclose the extension cable reel as described above, wherein said axle (11) comprises a plurality of drums (2A, 2B) on at least one side, a predetermined length of drum electrical cable (6) mounted on each of said plurality of drums (2A, 2B).

It is another object of the present invention to disclose the extension cable reel as described above, wherein each predetermined length of drum electrical cable (6) is in electrical communication with said at least one plug (5) via at least one slip ring (13, 14, 15) and a member of a group consisting of a two-way contact spring (12), a leaf spring, a brush and any combination thereof.

It is another object of the present invention to disclose the extension cable reel as described above, wherein at least one member of a group comprising said first drum (2A, 2B), said second drum (2A, 2B), and said plurality of drums (2A, 2B) comprises at least two predetermined lengths of electrical cable (6).

It is another object of the present invention to disclose an extension cable reel comprising:
a central body (1) having a first face on a first side of said central body (1) and a second face on a second side of said central body (1), said second face being on an opposite side of said central body (1) from said first face;
an axle (11) extending perpendicular to a main plane of said central body (1), said axle (11) extending outward from said first face of said central body (1) and extending outward from said second face of said central body (1);
a first drum (2A, 2B), freely rotatably mounted on said axle (11) on said first side, said first drum (2A, 2B) having a first drum internal face (2B) adjacent to said first face of said central body (1) and a first drum external face (2A) opposite to said first drum internal face (2B);
a second drum (2A, 2B), freely rotatably mounted on said axle (11) on said second side, said second drum (2A, 2B) having a second drum internal face (2B) adjacent to said second face and a second drum external face (2A) opposite to said second drum internal face (2B);
at least one first predetermined length of electrical cable (6) having a proximal end attached to said first drum (2A, 2B), said at least one first predetermined length of electrical cable (6) having a first distal end in electrical communication with at least one plug (5), said first proximal end in electrical communication with said central body (1), said at least one first predetermined length of electrical cable (6) being reversibly windable on said first drum; and
at least one second predetermined length of electrical cable (6) having a proximal end attached to said second drum (2A, 2B), said at least one second predetermined length of electrical cable (6) having a second distal end in electrical communication with at least one electrical socket (4), said second proximal end in electrical communication with said central body (1), said at least one second predetermined length of electrical cable (6) being reversibly windable on said second drum;
wherein said at least one first predetermined length of electrical cable (6) is in electrical communication with said at least one second predetermined length of electrical cable (6).

It is another object of the present invention to disclose the extension cable reel as described above, wherein each current-conducting wire of said at least one first predetermined length of electrical cable (6) is in electrical communication with a current conducting wire of said at least one second predetermined length of electrical cable (6) via at least one first slip ring (13, 14, 15) on said first drum (2A, 2B) and at least one second slip ring (13, 14, 15) on said second drum (2A, 2B), each of said at least one first slip ring (13, 14, 15) and said at least one second slip ring (13, 14, 15) in electrical communication via at least one two-way contact spring (12).

It is another object of the present invention to disclose the extension cable reel as described above, wherein said central body (1) comprises a supporting member selected from a group consisting of a leg, a carrying handle, a mounting bracket and any combination thereof.

It is another object of the present invention to disclose the extension cable reel as described above, additionally comprising a member of a group consisting of a first non-rotating external face (20), a second non-rotating external face (20) and any combination thereof, said first non-rotating external face (20) being in mechanical communication with said central body (1) on said first side and said second non-rotating external face (20) being in mechanical communication with said central body (1) on said second side.

It is another object of the present invention to disclose the extension cable reel as described above, additionally comprising an accessory selected from a group consisting of an electrical socket (8), a lithium battery charging socket (17), a 5V USB battery charging socket (10), a charging socket for other rechargeable batteries, a reset switch (9), a winding handle (3), a power-on light (16) and any combination thereof.

It is another object of the present invention to disclose the extension cable reel as described above, wherein said accessory is in mechanical communication with a member of a group consisting of said first drum external face (2A), said second drum external face (2A), said first non-rotating external face (20) and said second non-rotating external face (20).

It is another object of the present invention to disclose the extension cable reel as described above, wherein at least one of a group consisting of said first drum (2A, 2B) and said second drum (2A, 2B) comprises a cable end holder (7).

It is another object of the present invention to disclose the extension cable reel as described above, wherein at least one of a group consisting of said first drum (2A, 2B) and said second drum (2A, 2B) comprises a cable rewinding mechanism.

It is another object of the present invention to disclose the extension cable reel as described above, wherein said cable rewinding mechanism comprises at least one spring.

It is another object of the present invention to disclose the extension cable reel as described above, additionally comprising a cable rewind stop.

It is another object of the present invention to disclose the extension cable reel as described above, wherein said axle (11) comprises a plurality of drums (2A, 2B) on at least one side, a predetermined length of drum electrical cable (6) mounted on each of said plurality of drums (2A, 2B).

It is another object of the present invention to disclose the extension cable reel as described above, wherein each predetermined length of drum electrical cable (6) is in electrical communication with said at least one plug (5) via at least one slip ring (13, 14, 15) and a member of a group consisting of a two-way contact spring (12), a leaf spring, a brush and any combination thereof.

It is another object of the present invention to disclose the extension cable reel as described above, wherein at least one member of a group comprising said first drum (2A, 2B), said second drum (2A, 2B), and said plurality of drums (2A, 2B) comprises at least two predetermined lengths of electrical cable (6).

It is another object of the present invention to disclose a method of generating an extension cable reel, comprising steps of:
providing a central body (1) having a first face on a first side of said central body (1) and a second face on a second side of said central body (1), said second face being on an opposite side of said central body (1) from said first face; and
providing at least one first predetermined length of electrical cable (6) in electrical communication with at least one second predetermined length of electrical cable (6) via said central body (1);
wherein said method additionally comprises steps of:
   extending an axle (11) from said central body (1), said axle (11) extending perpendicular to a main plane of said central body (1), said axle (11) extending outward from said first side of said central body (1) and extending outward from said second side of said central body (1);
   freely rotatably mounting a first drum (2A, 2B) on said axle (11) on said first side, said first drum (2A, 2B) having a first drum internal face (2B) adjacent to said first face of said central body (1) and a first drum external face (2A) opposite to said first drum internal face (2B);
   attaching a first proximal end of said at least one first predetermined length of electrical cable (6) to said first drum (2A, 2B), said first proximal end in electrical communication with said central body (1);
   placing at least one plug (5) in electrical communication with a first distal end of said at least one first predetermined length of electrical cable (6);
   reversibly winding said at least one first predetermined length of electrical cable (6) on said first drum;
   freely rotatably mounting a second drum (2A, 2B) on said axle (11) on said second side, said second drum (2A, 2B) having a second drum internal face (2B) adjacent to said second face and a second drum external face (2A) opposite to said second drum internal face (2B);
   attaching a second proximal end of said at least one second predetermined length of electrical cable (6) to said second drum (2A, 2B), said second proximal end in electrical communication with said central body (1);
   placing at least at least one electrical socket (4) in electrical communication with a second distal end of said at least one second predetermined length of electrical cable; and
   reversibly winding said at least one second predetermined length of electrical cable (6) on said second drum.

It is another object of the present invention to disclose the method as described above, additionally comprising a step of providing, for each current-conducting wire of said at least one first predetermined length of electrical cable (6), electrical communication with a current conducting wire of said at least one second predetermined length of electrical cable (6) via at least one first slip ring (13, 14, 15) on said first drum (2A, 2B) and at least one second slip ring (13, 14, 15) on said second drum (2A, 2B), each of said at least one first slip ring (13, 14, 15) and said at least one second slip ring (13, 14, 15) in electrical communication via at least one two-way contact spring (12).

It is another object of the present invention to disclose the method as described above, additionally comprising a step of providing said central body (1) comprising a supporting member selected from a group consisting of a leg, a carrying handle, a mounting bracket and any combination thereof.

It is another object of the present invention to disclose the method as described above, additionally comprising a step of providing a member of a group consisting of a first non-rotating external face (20), a second non-rotating external face (20) and any combination thereof, said first non-rotating external face (20) being in mechanical communication with said central body (1) on said first side and said second non-rotating external face (20) being in mechanical communication with said central body (1) on said second side.

It is another object of the present invention to disclose the method as described above, additionally comprising a step of providing an accessory selected from a group consisting of an electrical socket (4), a lithium battery charging socket (17), a 5V USB battery charging socket (10), a charging socket for other rechargeable batteries, a reset switch (9), a winding handle (3), a power-on light (16) and any combination thereof.

It is another object of the present invention to disclose the method as described above, additionally comprising a step of providing said accessory in mechanical communication with a member of a group consisting of said first drum external face (2A), said second drum external face (2A), said first non-rotating external face (20) and said second non-rotating external face (20).

It is another object of the present invention to disclose the method as described above, additionally comprising a step of providing at least one of a group consisting of said first drum (2A, 2B) and said second drum (2A, 2B) comprising a cable end holder (7).

It is another object of the present invention to disclose the method as described above, additionally comprising a step of providing at least one of a group consisting of said first drum (2A, 2B) and said second drum (2A, 2B) comprising a cable rewinding mechanism.

It is another object of the present invention to disclose the method as described above, additionally comprising a step of providing said cable rewinding mechanism comprising at least one spring.

It is another object of the present invention to disclose the method as described above, additionally comprising a step of providing at least one cable rewind stop.

It is another object of the present invention to disclose the method as described above, additionally comprising steps of providing said axle (11) comprising a plurality of drums (2A, 2B) on at least one side, and mounting a predetermined length of drum electrical cable (6) on each of said plurality of drums (2A, 2B).

It is another object of the present invention to disclose the method as described above, additionally comprising a step of providing each predetermined length of drum electrical cable (6) in electrical communication with said at least one plug (5) via at least one slip ring (13, 14, 15) and a member of a group consisting of a two-way contact spring (12), a leaf spring, a brush and any combination thereof.

It is another object of the present invention to disclose the method as described above, additionally comprising a step of providing at least one member of a group comprising said first drum (2A, 2B), said second drum (2A, 2B), and said plurality of drums (2A, 2B) comprising at least two predetermined lengths of electrical cable (6).

It is another object of the present invention to disclose a method of providing electrical power at a distance from at least one electrical socket in electrical communication with at least one power supply, comprising steps of:
providing an extension cable reel comprising:
   a central body (1) having a first face on a first side of said central body (1) and a second face on a second side of said central body (1), said second face being on an opposite side of said central body (1) from said first face; and
   at least one first predetermined length of electrical cable (6) in electrical communication with at least one second predetermined length of electrical cable (6) via said central body (1);
wherein
   said central body (1) has an axle (11) extending perpendicular to a main plane of said central body (1), said axle (11) extending outward from said first side of said central body (1) and extending outward from said second side of said central body (1);
   a first drum (2A, 2B), freely rotatably mounted on said axle (11) on said first side, said first drum (2A, 2B) having a first drum internal face (2B) adjacent to said first face of said central body (1) and a first drum external face (2A) opposite to said first drum internal face (2B);
   a second drum (2A, 2B), freely rotatably mounted on said axle (11) on said second side, said second drum (2A, 2B) having a second drum internal face (2B) adjacent to said second face and a second drum external face (2A) opposite to said second drum internal face (2B); said at least one first predetermined length of electrical cable (6) having a first proximal end attached to said first drum (2A, 2B) and a first distal end in electrical communication with at least one plug (5), said first proximal end in electrical communication with said central body (1), said at least one first predetermined length of electrical cable (6) being reversibly windable on said first drum; and
   said at least one second predetermined length of electrical cable (6) having a second proximal end attached to said second drum (2A, 2B) and a second distal end in electrical communication with at least one electrical socket (4), said second proximal end in electrical communication with said central body (1), said at least one second predetermined length of electrical cable (6) being reversibly windable on said second drum;
electrically connecting said at least one plug (5) to said at least one electrical socket in electrical communication with at least one power supply;
unreeling at least a first portion of said at least one first predetermined length of electrical cable (6) from said first drum;
unreeling at least a second portion of said at least one second predetermined length of electrical cable (6) from said second drum;
attaching at least one electrically powered tool to said at least one electrical socket (4);
wherein a length of said at least a first portion of said at least one first predetermined length of electrical cable (6) is the same as a length of said at least a second portion of said at least one second predetermined length of electrical cable (6).

It is another object of the present invention to disclose the method as described above, additionally comprising a step of providing, for each current-conducting wire of said at least one first predetermined length of electrical cable (6), electrical communication with a current conducting wire of said at least one second predetermined length of electrical cable (6) via at least one first slip ring (13, 14, 15) on said first drum (2A, 2B) and at least one second slip ring (13, 14, 15) on said second drum (2A, 2B), each of said at least one first slip ring (13, 14, 15) and said at least one second slip ring (13, 14, 15) in electrical communication via at least one two-way contact spring (12).

It is another object of the present invention to disclose the method as described above, additionally comprising a step of providing said central body (1) comprising a supporting member selected from a group consisting of a leg, a carrying handle, a mounting bracket and any combination thereof.

It is another object of the present invention to disclose the method as described above, additionally comprising a step of providing a member of a group consisting of a first non-rotating external face (20), a second non-rotating external face (20) and any combination thereof, said first non-rotating external face (20) being in mechanical communication with said central body (1) on said first side and said second non-rotating external face (20) being in mechanical communication with said central body (1) on said second side.

It is another object of the present invention to disclose the method as described above, additionally comprising a step of providing an accessory selected from a group consisting of an electrical socket (4), a lithium battery charging socket (17), a 5V USB battery charging socket (10), a charging socket for other rechargeable batteries, a reset switch (9), a winding handle (3), a power-on light (16) and any combination thereof.

It is another object of the present invention to disclose the method as described above, additionally comprising a step of providing said accessory in mechanical communication with a member of a group consisting of said first drum external face (2A), said second drum external face (2A), said first non-rotating external face (20), and said second non-rotating external face (20).

It is another object of the present invention to disclose the method as described above, additionally comprising a step of providing at least one of a group consisting of said first drum (2A, 2B) and said second drum (2A, 2B) comprising a cable end holder (7).

It is another object of the present invention to disclose the method as described above, additionally comprising a step of providing at least one of a group consisting of said first drum (2A, 2B) and said second drum (2A, 2B) comprising a cable rewinding mechanism.

It is another object of the present invention to disclose the method as described above, additionally comprising a step of providing said cable rewinding mechanism comprising at least one spring.

It is another object of the present invention to disclose the method as described above, additionally comprising a step of providing at least one cable rewind stop.

It is another object of the present invention to disclose the method as described above, additionally comprising steps of providing said axle (11) comprising a plurality of drums (2A, 2B) on at least one side, and mounting a predetermined length of drum electrical cable (6) on each of said plurality of drums (2A, 2B).

It is another object of the present invention to disclose the method as described above, additionally comprising a step of providing each predetermined length of drum electrical cable (6) in electrical communication with said at least one plug (5) via at least one slip ring (13, 14, 15) and a member of a group consisting of a two-way contact spring (12), a leaf spring, a brush and any combination thereof.

It is another object of the present invention to disclose the method as described above, additionally comprising a step of providing at least one member of a group comprising said first drum (2A, 2B), said second drum (2A, 2B), and said plurality of drums (2A, 2B) comprising at least two predetermined lengths of electrical cable (6).

It is another object of the present invention to disclose a method of generating an extension cable reel, comprising steps of:
providing a central body (1) having a first face on a first side of said central body (1) and a second face on a second side of said central body (1), said second face being on an opposite side of said central body (1) from said first face;
extending an axle (11) from said central body (1), said axle (11) extending perpendicular to a main plane of said central body (1), said axle (11) extending outward from said first face of said central body (1) and extending outward from said second face of said central body (1);
freely rotatably mounting a first drum (2A, 2B) on said axle (11) on said first side, said first drum (2A, 2B) having a first drum internal face (2B) adjacent to said first face of said central body (1) and a first drum external face (2A) opposite to said first drum internal face (2B);
attaching a first proximal end of said at least one first predetermined length of electrical cable (6) to said first drum (2A, 2B), said at least one first predetermined length of electrical cable (6), said first proximal end in electrical communication with said central body (1) placing at least one plug (5) in electrical communication with a first distal end of said at least one first predetermined length of electrical cable (6);
reversibly winding said at least one first predetermined length of electrical cable (6) on said first drum;
freely rotatably mounting a second drum (2A, 2B) on said axle (11) on said second side, said second drum (2A, 2B) having a second drum internal face (2B) adjacent to said second face and a second drum external face (2A) opposite to said second drum internal face (2B);
attaching a second proximal end of said at least one second predetermined length of electrical cable (6) to said second drum (2A, 2B), said second proximal end in electrical communication with said central body (1),
placing at least one electrical socket (4) in electrical communication with a second distal end of said at least one second predetermined length of electrical cable (6); and
reversibly winding said at least one second predetermined length of electrical cable (6) on said second drum;
thereby providing electrical communication between said at least one first predetermined length of electrical cable (6) and said at least one second predetermined length of electrical cable (6).

It is another object of the present invention to disclose the method as described above, additionally comprising a step of providing, for each current-conducting wire of said at least one first predetermined length of electrical cable (6), electrical communication with a current conducting wire of said at least one second predetermined length of electrical cable (6) via at least one first slip ring (13, 14, 15) on said first drum (2A, 2B) and at least one second slip ring (13, 14, 15) on said second drum (2A, 2B), each of said at least one first slip ring (13, 14, 15) and said at least one second slip ring (13, 14, 15) in electrical communication via at least one two-way contact spring (12).

It is another object of the present invention to disclose the method as described above, additionally comprising a step of providing said central body (1) comprising a supporting member selected from a group consisting of a leg, a carrying handle, a mounting bracket and any combination thereof.

It is another object of the present invention to disclose the method as described above, additionally comprising a step of providing a member of a group consisting of a first non-rotating external face (20), a second non-rotating external face (20) and any combination thereof, said first non-rotating external face (20) being in mechanical communication with said central body (1) on said first side and said second non-rotating external face (20) being in mechanical communication with said central body (1) on said second side.

It is another object of the present invention to disclose the method as described above, additionally comprising a step of providing an accessory selected from a group consisting of an electrical socket (4), a lithium battery charging socket (17), a 5V USB battery charging socket (10), a charging socket for other rechargeable batteries, a reset switch (9), a winding handle (3), a power-on light (16) and any combination thereof.

It is another object of the present invention to disclose the method as described above, additionally comprising a step of providing said accessory in mechanical communication with a member of a group consisting of said first drum external face (2A), said second drum external face (2A), said first non-rotating external face (20) and said second non-rotating external face (20).

It is another object of the present invention to disclose the method as described above, additionally comprising a step of providing at least one of a group consisting of said first drum (2A, 2B) and said second drum (2A, 2B) comprising a cable end holder (7).

It is another object of the present invention to disclose the method as described above, additionally comprising a step of providing at least one of a group consisting of said first drum (2A, 2B) and said second drum (2A, 2B) comprising a cable rewinding mechanism.

It is another object of the present invention to disclose the method as described above, additionally comprising a step of providing said cable rewinding mechanism comprising at least one spring.

It is another object of the present invention to disclose the method as described above, additionally comprising a step of providing at least one cable rewind stop.

It is another object of the present invention to disclose the method as described above, additionally comprising steps of providing said axle (11) comprising a plurality of drums (2A, 2B) on at least one side, and mounting a predetermined length of drum electrical cable (6) on each of said plurality of drums (2A, 2B).

It is another object of the present invention to disclose the method as described above, additionally comprising a step of providing each predetermined length of drum electrical cable (6) in electrical communication with said at least one plug (5) via at least one slip ring (13, 14, 15) and a member of a group consisting of a two-way contact spring (12), a leaf spring, a brush and any combination thereof.

It is another object of the present invention to disclose the method as described above, additionally comprising a step of providing at least one member of a group comprising said first drum (2A, 2B), said second drum (2A, 2B), and said plurality of drums (2A, 2B) comprising at least two predetermined lengths of electrical cable (6).

It is another object of the present invention to disclose a method of providing electrical power at a distance from at least one electrical socket in electrical communication with at least one power supply, comprising steps of:
providing an extension cable reel comprising:
   a central body (1) having a first face on a first side of said central body (1) and a second face on a second side of said central body (1), said second face being on an opposite side of said central body (1) from said first face;
   an axle (11) extending perpendicular to a main plane of said central body (1), said axle (11) extending outward from said first face of said central body (1) and extending outward from said second face of said central body (1);
   a first drum (2A, 2B), freely rotatably mounted on said axle (11) on said first side, said first drum (2A, 2B) having a first drum internal face (2B) adjacent to said first face of said central body (1) and a first drum external face (2A) opposite to said first drum internal face (2B);
   a second drum (2A, 2B), freely rotatably mounted on said axle (11) on said second side, said second drum (2A, 2B) having a second drum internal face (2B) adjacent to said second face and a second drum external face (2A) opposite to said second drum internal face (2B);
   at least one first predetermined length of electrical cable (6) having a proximal end attached to said first drum (2A, 2B), said at least one first predetermined length of electrical cable (6) having a first distal end in electrical communication with at least one plug (5), said first proximal end in electrical communication with said central body (1), said at least one first predetermined length of electrical cable (6) being reversibly windable on said first drum; and
   at least one second predetermined length of electrical cable (6) having a proximal end attached to said second drum (2A, 2B), said at least one second predetermined length of electrical cable (6) having a second distal end in electrical communication with at least one electrical socket (4), said second proximal end in electrical communication with said central body (1), said at least one second predetermined length of electrical cable (6) being reversibly windable on said second drum;
electrically connecting said at least one plug (5) to said at least one electrical socket in electrical communication with at least one power supply;
unreeling at least a first portion of said at least one first predetermined length of electrical cable (6) from said first drum;
unreeling at least a second portion of said at least one second predetermined length of electrical cable (6) from said second drum;
attaching at least one electrically powered tool to said at least one electrical socket (4);
wherein a length of said at least a first portion of said at least one first predetermined length of electrical cable (6) is the same as a length of said at least a second portion of said at least one second predetermined length of electrical cable (6).
further wherein said at least one first predetermined length of electrical cable (6) is in electrical communication with said at least one second predetermined length of electrical cable (6).

It is another object of the present invention to disclose the method as described above, additionally comprising a step of providing, for each current-conducting wire of said at least one first predetermined length of electrical cable (6), electrical communication with a current conducting wire of said at least one second predetermined length of electrical cable (6) via at least one first slip ring (13, 14, 15) on said first drum (2A, 2B) and at least one second slip ring (13, 14, 15) on said second drum (2A, 2B), each of said at least one first slip ring (13, 14, 15) and said at least one second slip ring (13, 14, 15) in electrical communication via at least one two-way contact spring (12).

It is another object of the present invention to disclose the method as described above, additionally comprising a step of providing said central body (1) comprising a supporting member selected from a group consisting of a leg, a carrying handle, a mounting bracket and any combination thereof.

It is another object of the present invention to disclose the method as described above, additionally comprising a step of providing a member of a group consisting of a first non-rotating external face (20), a second non-rotating external face (20) and any combination thereof, said first non-rotating external face (20) being in mechanical communication with said central body (1) on said first side and said second non-rotating external face (20) being in mechanical communication with said central body (1) on said second side.

It is another object of the present invention to disclose the method as described above, additionally comprising a step of providing an accessory selected from a group consisting of an electrical socket (4), a lithium battery charging socket (17), a 5V USB battery charging socket (10), a charging socket for other rechargeable batteries, a reset switch (9), a winding handle (3), a power-on light (16) and any combination thereof.

It is another object of the present invention to disclose the method as described above, additionally comprising a step of providing said accessory in mechanical communication with a member of a group consisting of said first drum external face (2A), said second drum external face (2A), said first non-rotating external face (20) and said second non-rotating external face (20).

It is another object of the present invention to disclose the method as described above, additionally comprising a step of providing at least one of a group consisting of said first drum (2A, 2B) and said second drum (2A, 2B) comprising a cable end holder (7).

It is another object of the present invention to disclose the method as described above, additionally comprising a step of providing at least one of a group consisting of said first drum (2A, 2B) and said second drum (2A, 2B) comprising a cable rewinding mechanism.

It is another object of the present invention to disclose the method as described above, additionally comprising a step of providing said cable rewinding mechanism comprising at least one spring.

It is another object of the present invention to disclose the method as described above, additionally comprising a step of providing at least one cable rewind stop.

It is another object of the present invention to disclose the method as described above, additionally comprising steps of providing said axle (11) comprising a plurality of drums (2A, 2B) on at least one side, and mounting a predetermined length of drum electrical cable (6) on each of said plurality of drums (2A, 2B).

It is another object of the present invention to disclose the method as described above, additionally comprising a step of providing each predetermined length of drum electrical cable (6) in electrical communication with said at least one plug (5) via of a two-way contact spring (12), a leaf spring, a brush and any combination thereof.

It is another object of the present invention to disclose the method as described above, additionally comprising a step of providing at least one member of a group comprising said first drum (2A, 2B), said second drum (2A, 2B), and said plurality of drums (2A, 2B) comprising at least two predetermined lengths of electrical cable (6).

### BRIEF DESCRIPTION OF THE FIGURES

In order to better understand the invention and its implementation in practice, a plurality of embodiments will now be described, by way of non-limiting example only, with reference to the accompanying drawings, wherein

FIG. 1A-E illustrates examples of the prior art;

FIG. 2A-B show damage to electrical cables due to overheating;

FIG. 3 illustrates an electrical tool with a short electrical cord;

FIG. 4A-D schematically illustrates an embodiment of an extension cable reel of the present invention;

FIG. 5A schematically illustrates an embodiment of the drum with the cable fully unreeled, showing the cable connected to the drum central core and to a plug;

FIG. 5B schematically illustrates an embodiment of the drum of with the cable fully unreeled, showing the cable connected to the drum central core and to an electrical socket;

FIG. 6A-B schematically illustrates connecting a plug to a socket without and with a cable end holder;

FIG. 7 schematically illustrates a partially-exploded view of the extension cable reel;

FIG. 8 schematically illustrates an exploded view of the extension cable reel;

FIG. 9 schematically illustrates a two-way contact spring; and

FIG. 10A-B schematically illustrates accessories attached to the central body;

FIG. 11 schematically illustrates an embodiment of the extension cable reel with a pull handle and wheels;

FIG. 12A-D schematically illustrates an embodiment of an extension hose reel configured to allow fluids to pass therethrough; and

FIGS. 13 and 14 schematically illustrate partially-exploded views of an embodiment of an extension hose reel configured to allow fluids to pass therethrough.

### DETAILED DESCRIPTION OF THE PREFERRED EMBODIMENTS

The following description is provided, alongside all chapters of the present invention, so as to enable any person skilled in the art to make use of said invention and sets forth the best modes contemplated by the inventor of carrying out this invention. Various modifications, however, will remain apparent to those skilled in the art, since the generic principles of the present invention have been defined specifically to provide a means and method for providing an extension cable reel with a plurality of drums, each drum carrying a length of electrical cable. Each electrical cables is in electrical communication at all times with at least one electrical cable on at least one other drum so that power can be communicated from a free end of one cable to a free end of a second cable. Electrical communication does not depend on whether a drum is stationary or rotating, nor does it depend on whether a cable is laid out or is coiled around a drum.

The terms ‘electrical cord’ and ‘electrical cable’ hereinafter will be used synonymously to refer to the assembly of one or more bundled wires (typically two or more) that is used to carry electric current.

The term ‘fluid’ hereinafter refers to either a liquid or a gas.

The term ‘slip ring’ hereinafter refers to a conductive ring configured to enable transmission of an electrical signal (such as, but not limited to, any combination of power, current, voltage and data) from a source of electrical signal to a sink of electrical signal where the source of electrical signal and sink of electrical signal can rotate relative to each other. The electrical signal is transmissible from the source of electrical signal to the sink of electrical signal via the slip ring at all times, whether the source and sink are stationary relative to each other or whether the source and sink are rotating relative to each other.

The term ‘slip ring mechanism’ hereinafter refers to a device configured to transmit either an electrical signal or a fluid from a source to a sink at all times, whether the source and sink are stationary relative to each other or whether the source and sink are rotating relative to each other. Many types of slip ring mechanism are known in the art, both for electrical signal transmission and for fluid transmission.

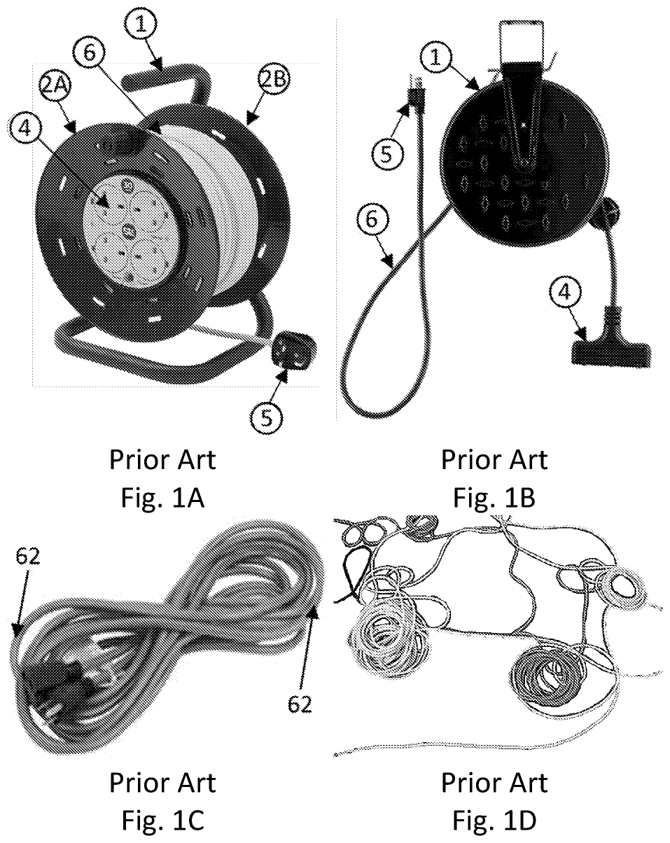

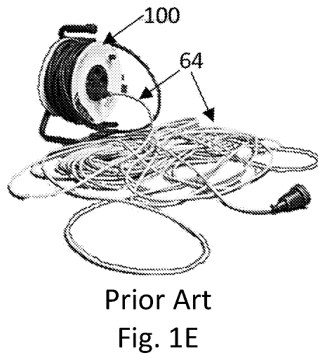

FIG. 1A-E illustrates examples of the prior art. In the prior art extension cable reel of FIG. 1A, which has an open support body (1), there is a single drum with two drum faces (2A, 2B) rotatably mounted on a support body (1). A reel of electrical cable (6) is mounted on the drum. A plug (5) is connected to the free end of the electrical cable (6), with one or more sockets (4) (in this example, four) mounted on the free face (2A) of the drum. It is not possible to mount sockets on the drum face (2B) adjacent to the support body (1), since the drum rotates with respect to the support body (1). In the prior art extension cable reel of FIG. 1B, which has a closed support body (1), the plug (5) is mounted to the support body (1) and the sockets (4) (in this case, three) are mounted to the free end of the electrical cable (6).

The prior-art extension cord of FIG. 1C illustrates a typical method of coiling an extension cord between uses. The tight bends (62) at the ends of the coil can damage the internal wires and, if the coil is not fully extended during use, there can be induction and unwanted heating near the tight bends (62).

The prior-art extension cords of FIG. 1D illustrate how easily extension cords, if they are not on reels, can get tangled and disarranged, leaving trip hazards as well as possible unwanted heating.

FIG. 1E illustrates use of a prior-art extension cable reel (100) with a long extension cord (64) attached to it. It can be seen that the extension cord can easily get tangled, get disconnected from the reel and become a tripping hazard. It will also be a tedious job rewinding it for storage when it is no longer needed. Loose extension cords, like the long extension cord (64) of FIG. 1E can develop permanent curl when an operator wraps the cord improperly. Many operators use their arm to wrap the cord. This wrapping motion puts a curl in the cord every time the cord is wrapped between the elbow and hand. So, in some cases, the cord could be curled 20 times on one complete wrap. Extension cords with a permanent curl become unsafe and need to be discarded.

Because the extension cord on a drum can overheat due to induction heating, in many jurisdictions, the length of the electrical cable in an extension cable reel is limited to no more than 50 m for a typical single-phase, 220V, 110A household-type extension cable reel. By splitting the cable across a plurality of drums, overheating would be much less of a problem in a multiple drum extension cable reel than in a single-drum extension cable reel. For example, a two-drum extension cable reel would have only 25 m of cable on each drum, thereby significantly reducing the amount of heating to be expected.

It is well known that a coil of wire carrying AC current will generate a rapidly-changing magnetic field. This rapidly-changing magnetic field will cause induction heating of metals within the coil. For a reel of electrical cable, every layer of coil inside the outermost one will be heated by layers outside itself and will heat layers inside itself. This limits the number of layers of coil in an extension cord, leading to a limit, in many jurisdictions, of 50 m for the length of a standard one-phase electrical cable in an extension cable reel. It also leads to a minimum size for the diameter of the innermost coil so that, in preferred embodiments of the electrical cable extension reel of the present invention, as in conventional drums for reel extension cables, the drum central core comprises an outer cylindrical surface around which the cable is wound and an inner cylindrical surface with a diameter slightly larger than the axle diameter, with the inner cylindrical surface resting on the axle.

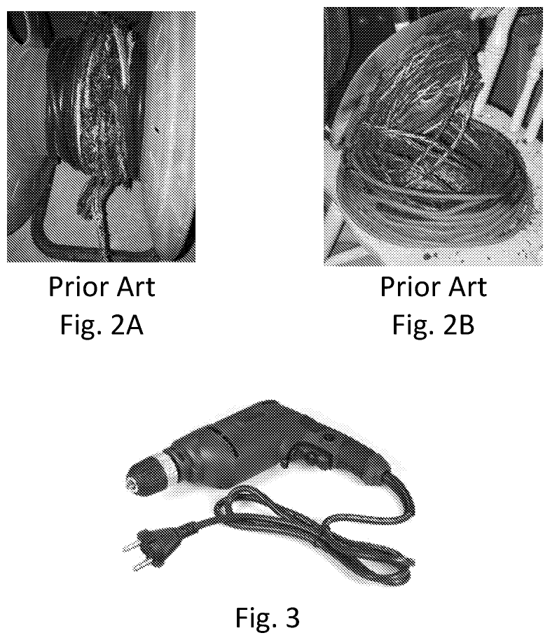

FIG. 2A-B illustrate damage to electrical cables caused by overheating and burning. In FIG. 2A, all except the three left-most loops of cable are burned, while in FIG. 2B, all of the inner loops of cable are burned, with scorch extending onto the drum, in the upper left. It is for this reason that preferred embodiments of the extension cable reel of the present invention comprise a thermal overheat cutout.

FIG. 3 illustrates an electrical tool with a length of electrical cord typical of modern tools, about 1 m, showing how short the electrical cord is and how much need there is for extension cords.

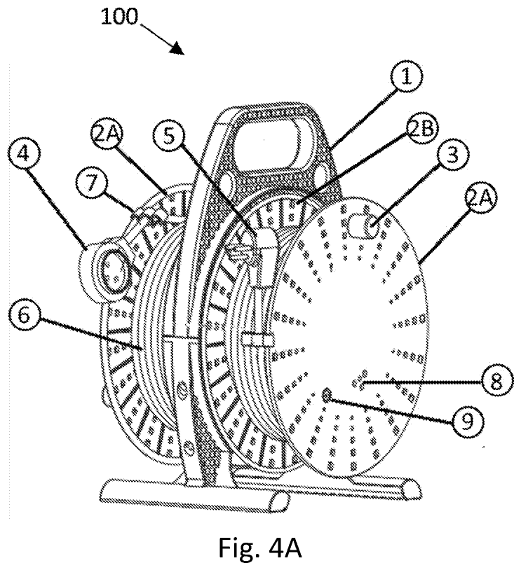

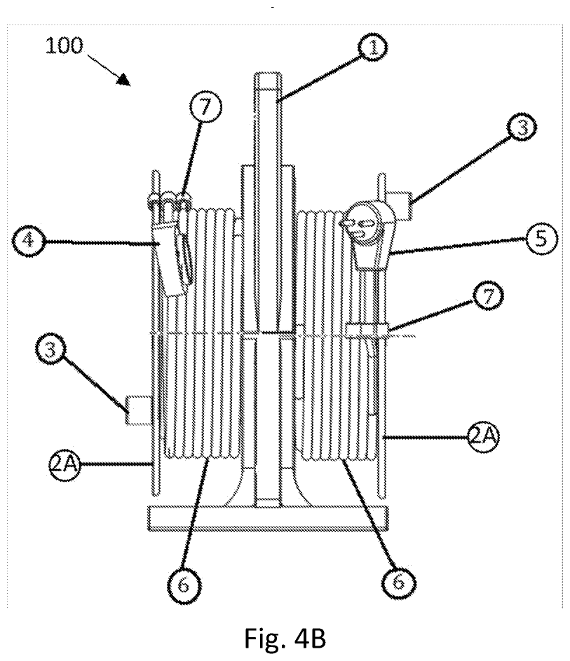

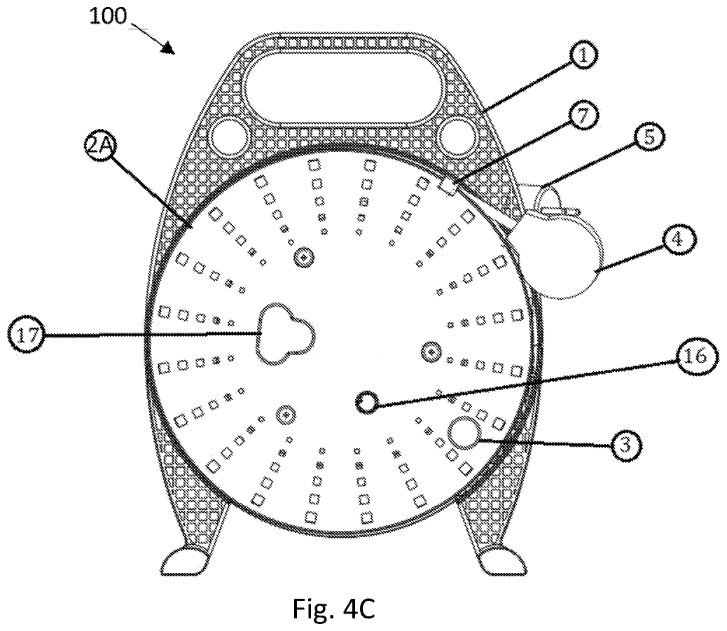

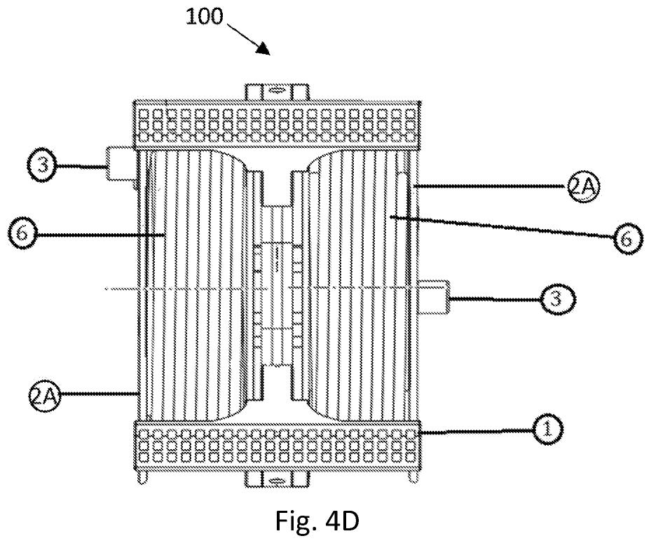

FIG. 4A-D illustrates an embodiment of the extension cable reel of the present invention. FIG. 4A shows a perspective view of the extension cable reel (100), while FIG. 4B shows an end-on plan view of the extension cable reel (100), FIG. 4C shows a side-on plan view of the extension cable reel (100) and FIG. 4D shows a top plan view of the extension cable reel (100).

The extension cable reel (100) of the present invention comprises a central body (1) with a drum on either side of the central body, each drum having two faces (2A, 2B), with one drum face, the internal drum face (2B), adjacent to the support body (1) and the other drum face, the external drum face (2A), exposed and thus free to accept sockets or other accessories. Each drum comprises a reel of electrical cable (6), with the amount of cable on each drum depending on the type of cable.

It should be noted that current EU standard IEC 61242:1995/AMD2:2015 limits the total length of cable on a single-phase, 220 V extension cable reel system to 50 m because of the problem of overheating, as shown in FIG. 2A-B. Therefore, under this standard, the amount of cable would be limited to 25 m per drum for the present invention. However, since the intent of the standard is to limit overheating, it would seem possible for the standard to be altered so that the maximum length of cable per drum is 50 meters, allowing a total maximum length of cable for a two-drum system of 100 meters.

The allowed length will be different for different voltage and current systems and different types of cable, and the allowed length can also depend on the load to be placed on the extension cable by the power tool(s) being used.

Because the electrical connections between the electrical cables (6) pass through the central body (1), both external faces (2A) can be used for power sockets or other accessories, unlike prior-art cable reels where only one face can be so used. One electrical cable (6) has a plug (5) at its free end, while the other electrical cable (6) has a socket (4) at its free end; no provision is made in the EU standards for devices like the extension cable reel of the present invention, which comprises more than one drum, thereby reducing the amount of cable on each drum and the amount of overheating.

The drums are mounted independently, so that each drum can rotate in either direction, independently of the other drum. On one drum, the free (distal) end of the electrical cable (6) comprises a plug (5) that can be connected to a power outlet. On the other drum, the free (distal) end of the electrical cable (6) comprises one or more sockets (4) into which electrical tools can be plugged. The drum (proximal) ends of the electrical cable (6) are in electrical communication with each other; when the plug (5) of the electrical cable (6) on one drum is connected to a source of electrical power, the power is available at all times to a tool plugged into the socket (4) at the free end of the electrical cable (6) on the other drum.

Since two drums are used, the diameter of the device can be much reduced. Since the drums are on either side of the support body (1), the weight of the extension cable reel is distributed on both sides of the support body (1), providing a balanced load that is easier to carry.

In preferred embodiments, the central body (1) comprises legs to stabilize the extension cable reel on the ground. The central body (1) can comprise at least one of a carrying handle and a mounting bracket as well as or instead of legs.

Each drum can be open or closed; a closed drum comprises a cover attached to the open side of the drum so that the electrical cable or hose, while reeled in, is not visible. Typically, the cover also hides the faces of the drum. In the illustrated embodiments, the drums are open.

Each drum has a hollow core (not shown) rotatably mounted on an axle attached to the central body. Typically, the hollow core has the shape of a circular cylinder with a horizontal main longitudinal axis, parallel to the main longitudinal axis of the axle. The hollow core is configured so that the drum can rotate freely in either direction about the axle. Unreeling of the cable from a drum and reeling of the cable onto the drum is accomplished by rotating the drum as it rests on the axle.

In some embodiments, the electrical cables are unreeled from the drum and rewound onto the drum manually. In other embodiments, the unreeling is manual, but the drum comprises a spring or other rewinding mechanism. In embodiments with a rewinding mechanism, a rewind stop can prevent undesired rewinding.

Prior art mobile extension cable reels typically have a support body on one side of the drum, with an axle extending from the body around which the drum rotates. Since the drum rotates with respect to the support body, it is very awkward to mount extra sockets or other accessories on the support body, leaving only one face of the device—the drum face not adjacent to the support body—available for extra accessories. In contrast, in the extension cable reel of the present invention, since the support body is between the two drums, there are two free drum faces, two drum faces not adjacent to the support body, both of which can be used for extra accessories.

Having all of the accessories connected to external drum faces (2A) can also prevent the known problem with prior-art extension cable reels of poor connection to the accessory, which can cause malfunctioning of or shorting of the accessory, sometimes leading to melting of the electrical cable and even, in extreme cases, fires.

Since there are two drums, amount of cable on each drum is half what it would be for extension cable reels of the prior art, significantly reducing the amount of heating of the parts of the electrical cable close to the axle, and thereby also reducing the possibility of overheating and of problems, such as melting of the electrical cable and fire due to overheating.

The extension cable reel (100) of the present invention, similar to prior art devices, preferably also comprises at least one of a winding handle (3), an electric socket housing (8), into which a user can insert a plug for an electrical appliance or a multiple socket extension lead, an automatic overload circuit breaker, preferably with a reset switch (9), and a cable end holder (7), which can stop the cable from coming unwound, can be used as a safety catch when connecting to another electrical cable and which can also assist in tidy winding of the electrical cable (6). onto the drum.

The automatic overload circuit breaker is configured to turn off current and voltage if at least one of the following is true: the power drawn is greater than a predetermined value, and the temperature of at least a portion of the device is above a predetermined value.

The reset switch (9) allows manual reset of the overload circuit breaker. In some embodiments, the device comprises an automatic reset switch, in addition to or as an alternative to the manual reset switch (9).

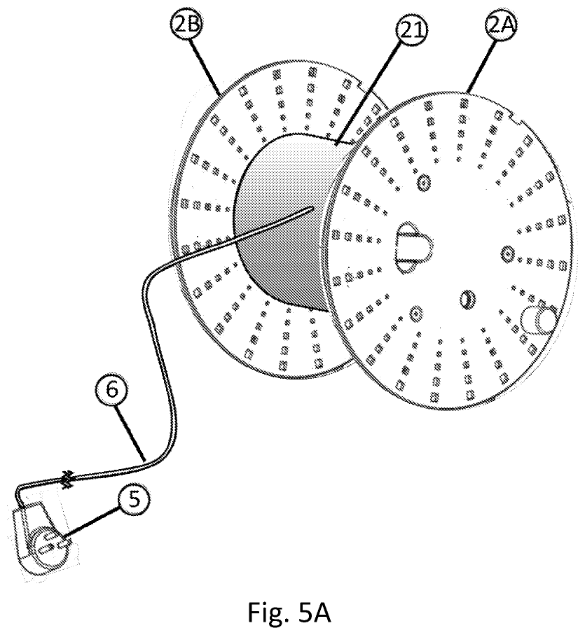

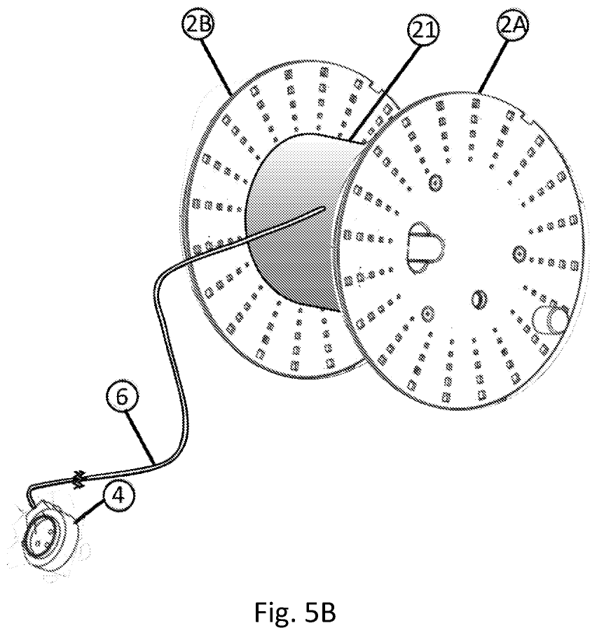

FIG. 5A schematically illustrates an embodiment of the drum (2A, 2B) with the cable (6) fully unreeled, showing the cable (6) connected at its proximal end to the drum central core (21) and, at its distal end, to a plug (5).

FIG. 5B schematically illustrates an embodiment of the drum (2A, 2B) with the cable (6) fully unreeled, showing the cable (6) connected at its proximal end to the drum central core (21) and, at its distal end, to an electrical socket (4).

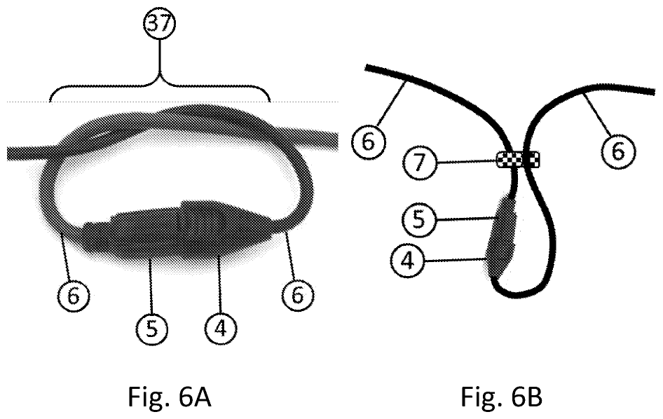

FIG. 6A-B illustrates how the cable end holder (7) can function as a safety catch. FIG. 6A illustrates two cables (6) connected together without a safety catch. The cables (6) are looped together (37) to prevent the plug (5) from detaching from the socket (4). However, if tension is put on the cables (6), then the loop (37) will tighten, putting an undesirably tight bend on the cables (6). FIG. 6B illustrates use of the cable end holder (7). The cables (6) are snapped into the cable end holder (7). Tension on the cables (6) will be transmitted to and put strain on the cable end holder (7), not on the cables (6), while preventing the tension from being transmitted to the plug (5) and socket (4) and preventing the plug (5) from detaching from the socket (4)

In some embodiments, the extension cable reel (100) of the present invention also comprises at least one of a battery charger for lithium batteries (17), a battery charger for other rechargeable batteries (not shown) and a power-on light (16).

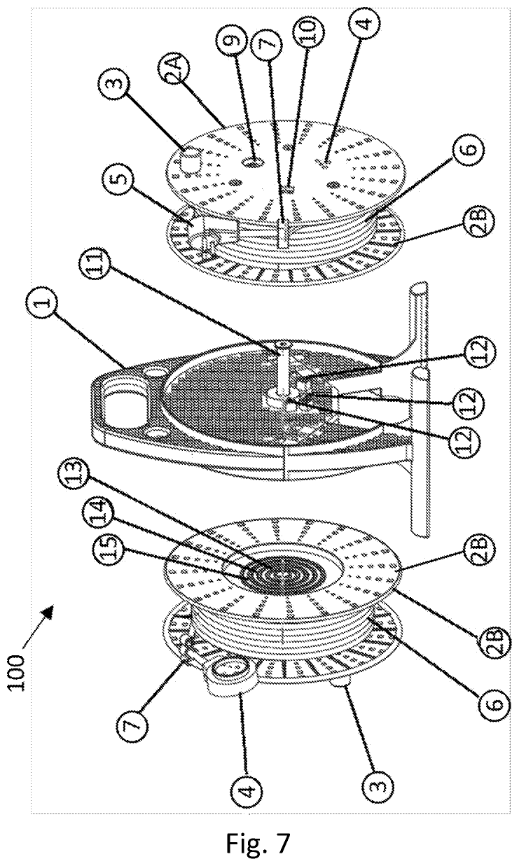

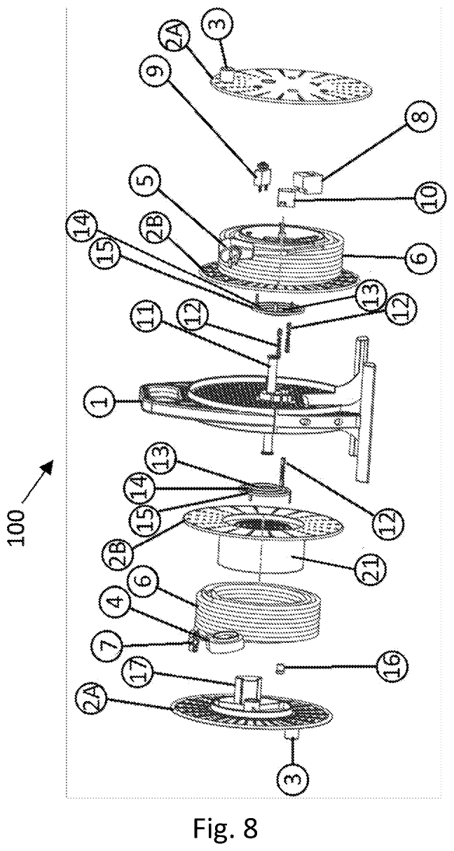

FIG. 7 schematically illustrates a partially-exploded view of the embodiment (100) of FIG. 4, while FIG. 8 schematically illustrates an exploded view of the embodiment (100) of FIG. 4.

FIG. 7 shows the central body (1) and half of the axle (11) attached to it (the other half extends from the opposite face of the central body (1)).

Each drum comprises an external face (2A) and an internal face (2B), the external face (2A) and internal face (2B) connected by a hollow central core (21, not shown).

For each drum, the drum central core (21, not shown) rests rotatably on the axle (11), with the drum internal face (2B) adjacent to a face of the central body (1). One or more two-way contact springs (12) (three are shown in this exemplary embodiment), which are configured to transmit power between the cables (6), pass through and are supported by the central body (1).

The two-way contact springs (12) are in contact with the slip rings (13, 14, 15) on the drum internal faces (2B), with the slip rings (13, 14, 15) in electrical communication with the cables (6). Each of the slip rings (13, 14, 15) is in communication with a single wire of the cable (6). For a typical single-phase extension cable reel, there are three slip rings per drum, one each for line, neutral, and ground. In preferred embodiments, the large slip rings (15) transmit line voltage, the medium slip rings (14) are for the ground line, and the small slip rings (13) are for the neutral line. A three-phase extension cable reel would have five slip rings per drum, one for each phase plus neutral and ground.

There is at least one two-way contact spring (12) for each slip ring (13, 14, 15). Preferably, there is one two-way contact spring (12) for each slip ring (13, 14, 15).

An advantage of the two-way contact spring (12) of the embodiment of FIGS. 4, 7 and 8 is that it comprises a single piece, lowering manufacturing costs and simplifying assembly, and also simplifying repair if replacement of a two-way contact spring (12) or a slip ring (13,14,15) is needed.

The device of the present invention is not limited to the slip rings and two-way contact springs disclosed above. Conventional means of providing electrical communication between the cables on the two drums are also possible.

For non-limiting example, in some embodiments, the mechanism to transmit power from one slip ring to another can comprise more than one part, for non-limiting example, a central spiral spring with two contact pins, one on each side of the spiral spring. In other embodiments, for non-limiting example, contact can be via at least one leaf spring or at least one brush. The leaf spring(s) can have flattened heads or attached cap-type heads to provide a wider contact area with the slip rings.

In some embodiments, one or more commercially-available slip ring mechanisms can be used to transmit power from a cable on one drum to a cable on another drum. A commercially-available slip ring can be of standard or customized design.

The number of slip rings can be in a range from 1 to 256.

A slip ring mechanism can provide communication for power transmission, fiber optic data transmission, coaxial data transmission, coaxial power transmission, electrical data transmission, and any combination thereof.

In some embodiments, transmission of fluid from one drum to another is by means of a fluid transmission slip ring mechanism. Fluid transmission slip ring mechanisms, known in the art, use different materials and different transmission mechanisms from A slip ring mechanism can provide fluid transmission, power transmission, fiber optic data transmission, coaxial data transmission, coaxial power transmission, electrical data transmission, and any combination thereof.

Connected to each drum, there is a predetermined length of electrical cable (6). One predetermined length of electrical cable (6) comprises at least one plug (5) at its free end and the other predetermined length of electrical cable (6) comprises at least one socket (4) at its free end. The inner (proximal) ends of the predetermined length of electrical cable (6) are in electrical communication via the at least one slip ring (13, 14, 15) and the at least one two-way contact spring (12) so that power entering one cable via the plug (5) can exit the other cable (6) via the socket (4). In this exemplary embodiment, three slip rings (13, 14, 15) and three two-way contact springs (12) are shown. This is a typical arrangement for a three-phase power system.

Typically, the number of slip rings (13, 14, 15) and the number of two-way contact springs (12) or other transmission mechanisms (brushes, coil springs, leaf springs, etc.) will equal the number of items to be transmitted (for non-limiting example, power phases or data communication lines).

Each drum can comprise, on its external face (2A), a winding handle (3), a cable end holder (7), at least one reset switch (9) and a 5V USB battery charging socket (10), as well as a battery charger for lithium batteries (17) (or a housing into which a lithium battery charger can be fitted), an additional electrical socket (not shown), another accessory and any combination of the above.

FIG. 8 schematically illustrates the drum central core (21), shown attached to the drum internal face (2B). FIG. 8 schematically illustrates, in addition to the components shown in FIG. 7, a power-on light (16), an electric socket housing (8) and an automatic heat switch (9), to turn off the power if there is overheating, the body of the 5V USB battery charging socket (10), and the body of the review lamp (16).

It should be noted that the use of the device of the present invention is not limited to an electrical cable reel. Non-limiting examples of other possible uses include communication cable and fluid cable. Non-limiting examples of fluid cable are hose reels for water pipes or for piping other liquids, and piping for pressurized air or other pressurized gases. A communication cable extension reel would have one slip-ring pair and at least one two-way contact spring for each of the communication wires in the cables.

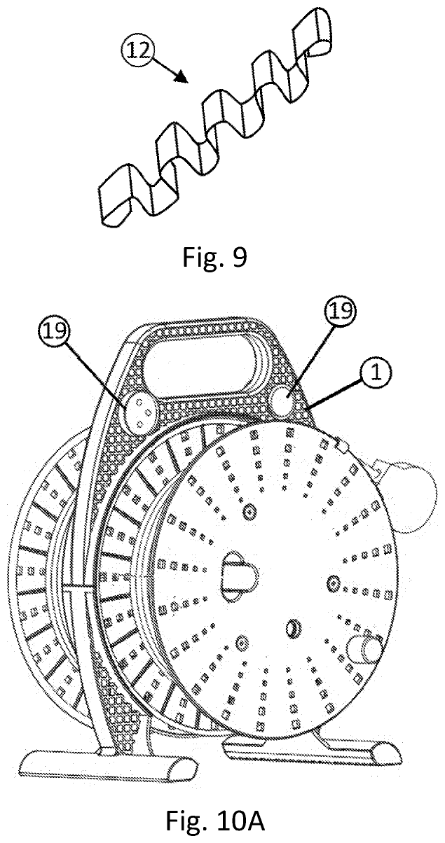

As shown in FIG. 9, a two-way contact spring (12) comprises bent flat ribbon, not wire. In use, a two-way contact spring (12) is slightly compressed, in order to ensure good electrical contact with a slip ring (13, 14, 15). The dimensions of a two-way contact spring (12) and the amount of compression will depend on the voltage and current system for which the extension cable reel is being used, on the type of cable, on what is being transmitted (for non-limiting example, power or data), and can also depend on the load to be placed on the extension cord (for non-limiting example, by the power tool(s) expected to be used) and the resistivity of the spring material.

Typically, the width of a two-way contact spring (12) is no more than the width of the slip ring.

As a non-limiting example of the size of a contact spring (12), for a typical single-phase extension cable reel for use with a 220 V to 240 V, 15 A power supply, the uncompressed length of a two-way contact spring (12) can be in a range from 1 cm to 10 cm, 3 cm to 8 cm, 4 cm to 6 cm, or 5 cm. The width of a two-way contact spring (12) can be in a range from 1 mm to 10 mm, 2 mm to 6 mm, 2 mm to 4 mm, or 5 mm. The total depth of a contact spring (12), from the bottom of a lower face to a top of an upper face, can be in a range from

As a non-limiting example of the size of a contact spring (12), for a typical single-phase extension cable reel for use with a 220 V to 240 V, 15 A power supply, the thickness of a spring steel two-way contact spring (12) can be in a range from 0.1 mm to 1 mm, 0.2 mm to 0.6 mm, or 0.3 mm.

The contact spring can comprise steel, copper alloy (such as, but not limited to, phosphor bronze), nickel alloy (such as, but not limited to cobalt-nickel alloy), titanium alloy, aluminum, and any combination thereof.

In some embodiments, for a typical single-phase 220 V extension cable reel, the amount of compression is about 3 mm; the amount of compression can be in a range from 1 mm to 10 mm.

The length, width and thickness of a two-way contact spring (12) are selected to minimize heating of the two-way contact spring (12) during use, while maintaining the stiffness of the two-way contact spring (12). Preferably, a temperature increase of the two-way contact spring (12) due to resistive losses during use will be less than about 1° C.; however, this value is indicative, for design purposes, and is not limiting.

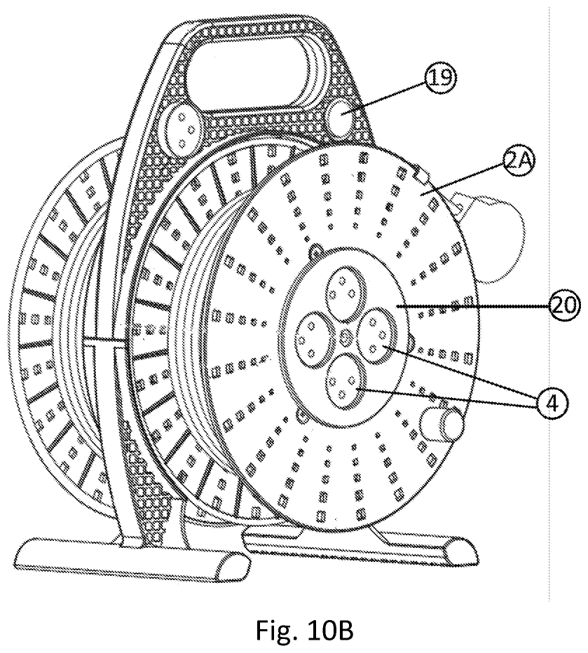

FIG. 10A-B illustrates embodiments with accessories. FIG. 10A schematically illustrates an embodiment with accessories (19), in this case electrical sockets, attached to the central body (1). The accessories (19) are in electrical communication with the cable (6) on at least one drum via electrical connections passing through the interior of the central body (1).

FIG. 10B schematically illustrates an embodiment with a plurality of electrical sockets (4), in this case, four, on a non-rotating external face (20).

In some embodiments, an accessory comprising, but not limited to, an electrical socket (4), a lithium battery charging socket (17), a 5V USB battery charging socket (10), a charging socket for other rechargeable batteries, a reset switch (9), a power-on light (16) and any combination thereof can be mounted to an external face of the drum.

In some embodiments, an accessory comprising, but not limited to, an electrical socket (4), a lithium battery charging socket (17), a 5V USB battery charging socket (10), a charging socket for other rechargeable batteries, a reset switch (9), a power-on light (16) and any combination thereof can be mounted to a non-rotating external face (20). The non-rotating external face (20) is in mechanical communication with the central body (1). The mechanical communication can be, for non-limiting example, via the axle (11), or via a cylinder mounted on the axle (11), with the drum (2A, 2B) rotating around the cylinder. In such embodiments, the accessory(s) do not rotate so that a device can remain connected to an accessory during use, without twisting a power cord or tangling multiple power cords while the drum rotates.

The embodiment of FIG. 10B also comprises electrical sockets (19) attached to the central body (1). The electrical sockets (19) attached to the central body (1), as in the embodiment of FIG. 10A, are in electrical communication with the cable (6) on at least one drum via electrical connections passing through the interior of the central body (1).

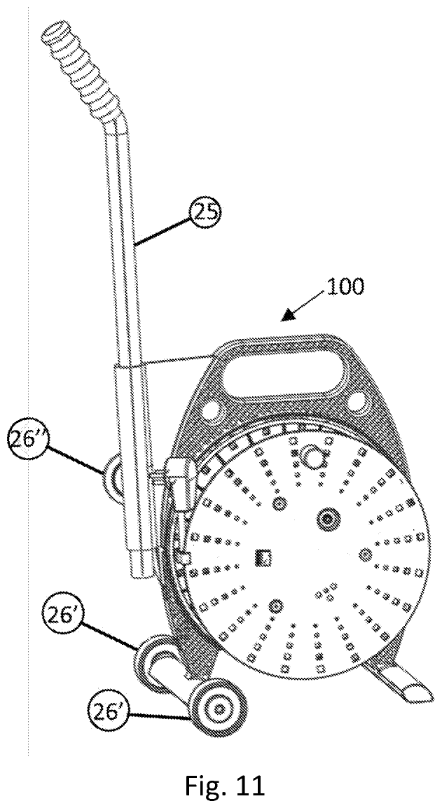

The embodiment of FIG. 11 comprises a handle (25) and wheels (26) configured to ease transportation of the device (100). One set of wheels (26′) allows the device to be moved with the handle substantially vertical. With all the wheels on the ground (26′ and 26″), the device can be moved with the handle substantially horizontal.

In the embodiment shown, for clarity, there is only one upper wheel (26″). However, the upper wheels (26″) can be paired like the lower wheels.

The rolling mechanism is typically a conventional mechanism, for non-limiting example, a rolling fixed wheel, a swiveling wheel, a roller, a caster, a swivel caster, a ball caster, a spherical wheel and any combination thereof.

In some embodiments, the extension cable reel is permanently mounted to the handle and wheels. In some embodiments, a member of a group consisting of a handle, a wheel and any combination thereof is separable from the extension cable reel.

In some embodiments, the extension cable reel comprises at least one stop mechanism for reversibly preventing at least one wheel from rotating, so as to prevent unwanted movement of the extension cable reel. Non-limiting examples of a stop mechanism are be a brake, a wheel lock, a bar reversibly lowerable to the ground or other underlying surface and any combination thereof.

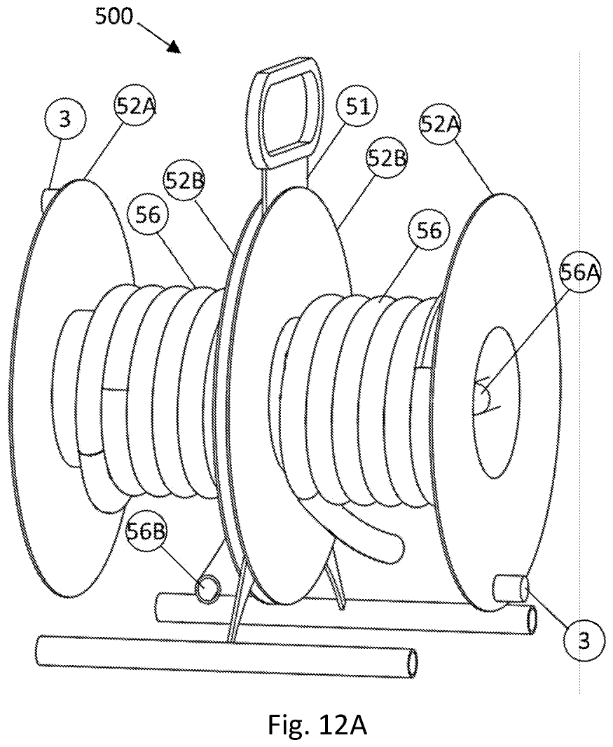

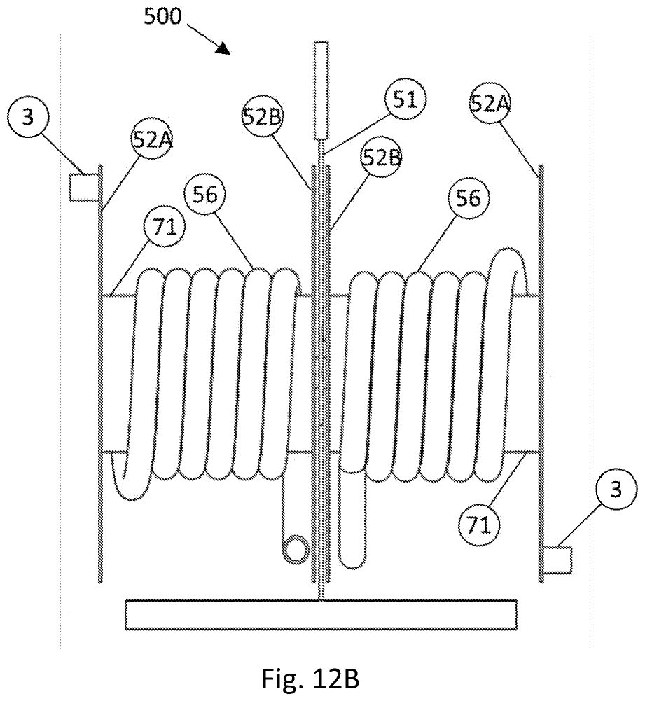

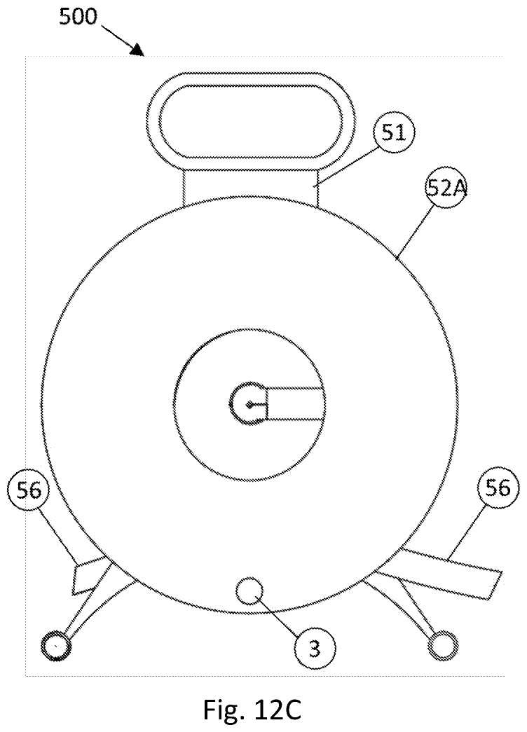

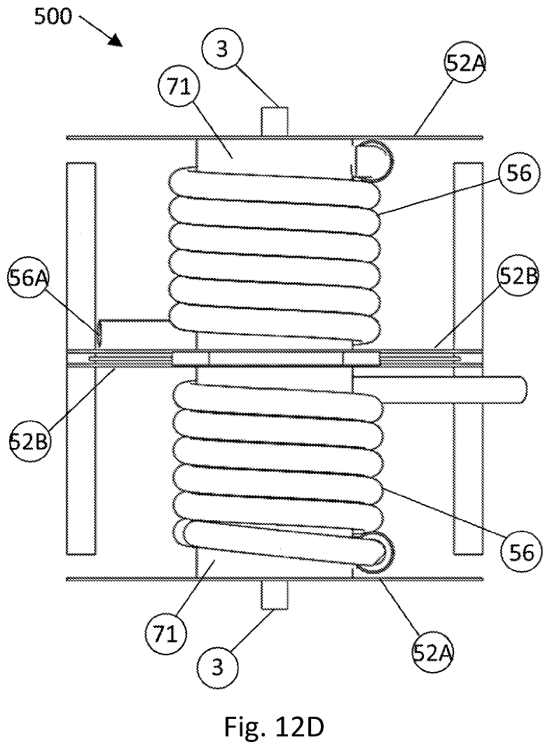

FIG. 12A-D illustrates an embodiment of an extension hose reel of the present invention, configured for the passage of fluids (liquids or gases) therethrough. FIG. 12A shows a perspective view of the extension hose reel (500), while FIG. 12B shows an end-on plan view of the extension hose reel (500), FIG. 12C shows a side-on plan view of the extension hose reel (500) and FIG. 12D shows a top plan view of the extension hose reel (500).

The extension hose reel (500) of the present invention comprises a central body (51) with a drum on either side of the central body, each drum having two faces (52A, 52B), with one drum face, the internal drum face (52B), adjacent to the support body (51) and the other drum face, the external drum face (52A), exposed and thus free to accept sockets or other accessories. Each drum comprises a reel of fluid hose (56), with the amount of hose on each drum depending on the type of hose, the type of fluid, and the pressure.

The allowed length will be different for different types of fluid, different operating pressures and different types of hose.

The drums are mounted independently, so that each drum can rotate in either direction, independently of the other drum. On each drum, the free (distal) end (56B) of the hose (56) comprises a connector (not shown) that can be connected to either a source of fluid or one or more dispensers of fluid (for non-limiting example, a sprayer, another length of hose, a valve, etc.). The drum (proximal) ends of hoses (56) are in fluid communication with each other, as discussed hereinbelow.

Since two drums are used, the diameter of the device can be much reduced. Since the drums are on either side of the support body (51), the weight of the extension hose reel is distributed on both sides of the support body (51), providing a balanced load that is easier to carry.

In preferred embodiments, the central body (51) comprises legs to stabilize the extension cable reel on the ground. The central body (51) can comprise at least one of a carrying handle and a mounting bracket as well as or instead of legs. The extension hose reel (500) can also comprise or be connectable to a handle and/or wheels, as shown above in FIG. 11.

Typically, each drum has a hollow core (71) rotatably mounted on an axle attached to the central body. Typically, the hollow core has the shape of a circular cylinder with a horizontal main longitudinal axis, parallel to the main longitudinal axis of the axle. The hollow core is configured so that the drum can rotate freely in either direction about the axle. Unreeling of the cable from a drum and reeling of the cable onto the drum is accomplished by rotating the drum as it rests on the axle.

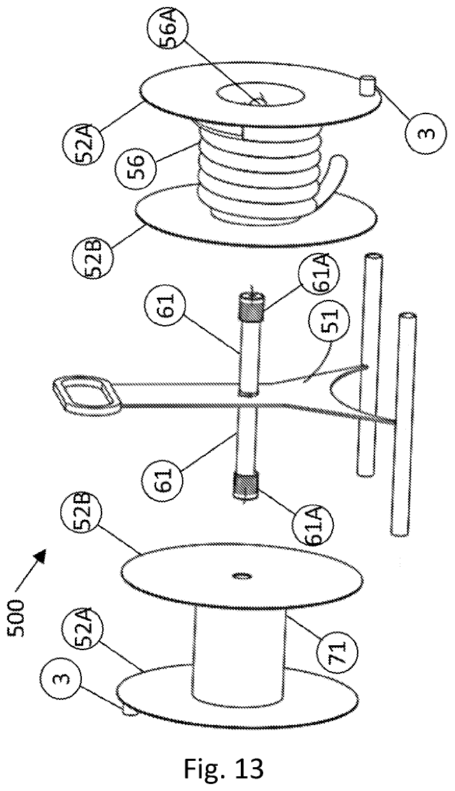

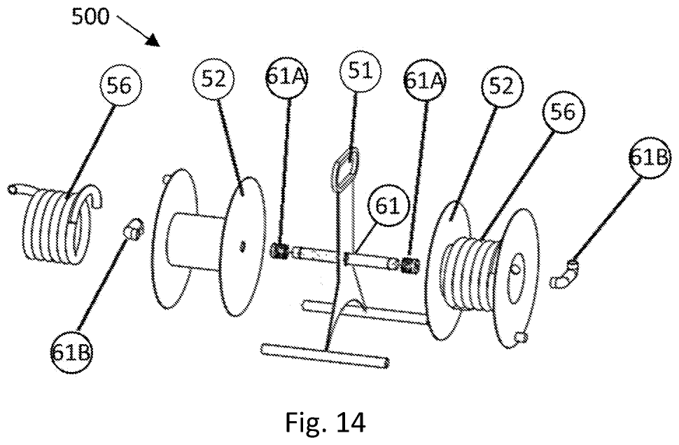

Each hose (56) is, at its proximal end, in fluid communication via an aperture in the drum core (56A) with a hollow axle (61, see FIGS. 13 and 14, below), thus allowing, as discussed hereinbelow, fluid connection between the two hoses (56).

Each drum can comprise, on its external face (52A), a winding handle (3) and a hose end holder (not shown),

In some embodiments, each hose can be unreeled from the drum and rewound onto the drum manually. In other embodiments, the unreeling is manual, but the drum comprises a spring or other rewinding mechanism. In embodiments with a rewinding mechanism, a rewind stop can prevent undesired rewinding.

FIG. 13 schematically illustrates a partially-exploded view of the embodiment (500) of FIG. 12, while FIG. 14 schematically illustrates a more-fully exploded view of the embodiment (500) of FIG. 12. For clarity, the hose (56) is shown only on the right-hand drum so that the central core (71) of the left-hand drum is visible. The winding handles (3) of the drums can be seen.

FIGS. 13 and 14 show the central body (51) and the axle (61) passing through the central body (51) and attached to the central body (51). The axle (61) is hollow, allowing fluid to pass therethrough. At each end of the axle is an axle fitting (61A), allowing the axle to be in fluid communication with the proximal end of a hose (56) via a hose fitting (not shown) on the proximal end of the hose. The axle fitting (61A) can be rotatably mounted on the axle (61) the hose fitting can be rotatably mounted on the hose (56), the hollow core (71) or both, the axle fitting (61A) can be rotatably connected to the hose fitting, and any combination thereof so as to allow the drum to rotate about a non-rotating axle while preserving a leak-free fluid connection between the hose (56) and the axle (61).

Each drum comprises an external face (52A) and an internal face (52B), the external face (52A) and internal face (52B) connected by a hollow central core (71).

For each drum, the drum central core (71) rests rotatably on the axle (61), with the drum internal face (52B) adjacent to a face of the central body (51).

FIG. 14 shows the axle fittings (61A) separated from the axle (61) and also shows the hose fittings (61B).

In some embodiments, the rotation of drums on opposite sides of the central body can be synchronized during rewinding of the cables so that the cables are reeled in at the same rate on both sides. Unreeling can be done independently (unsynchronized) for drums on opposite sides of the central body, can be synchronized, and any combination thereof. Reeling can be synchronized, unsynchronized and any combination thereof. Synchronization can be accomplished by means of 45-degree gears or by any other conventional means of providing synchronization of rewinding on different drums. Rewinding can be manual, spring-operated, or motor-driven.

The axle can be configured to carry drums of different widths, so that the amount of cable that is carried can be varied without changing the central body or the axle.

The system can be configured to carry drums of different diameters, so that the amount of cable that is carried can be varied without changing the central body or the axle.

The drums on the two sides of the central body need not be the same width or diameter, and need not carry the same length of cable or the same type of cable.

In some embodiments, the central body and/or the axle can be changed to accommodate a different number of drums, drums of different sizes, different types of electrical contact, different numbers of electrical contacts, and any combination thereof.

In some embodiments, the socket end of a cable can comprise at least one accessory selected from a group consisting of an electrical socket, a light source, a battery charger, a communication socket, and any combination thereof. In some variants of these embodiments with a plurality of sockets, different sockets can be configured for different voltages, for non-limiting example, a 220 V socket for power tools and a 5 V socket for a laptop.

In some embodiments, at least one drum further comprises a cable distribution mechanism, configured to ensure that the cable automatically winds evenly onto the drum during rewinding.

At least one side of the central body can comprise more than one drum. The central body and axle can be configured so that the number of drums on at least one side of the central body is variable.

A drum can comprise a single cable or a plurality of cables. If there are a plurality of cables, each cable can be in independent communication with at least one cable on a different drum, or at least two cables can share electrical communication with at least one cable on a different drum. If at least two cables share electrical communication with at least one cable on a different drum, at least two of these cables can be independent throughout their length on the drum, or at least one cable can split into two or more sub-cables at at least one point along its length.

The extension cable reel of the present invention can comprise, as disclosed above, a single type of cable or a single type of fluid hose. In some embodiments, it comprises a plurality of types of cable or a plurality of types of fluid hose.

Different types of reelable object can be on different drums or on the same drums. The types of reelable object can include: a power cable, a communication cable, a wire, a rope, a hawser, a cable comprising multiple links, a fluid hose, and any other conventional reelable object. Reelable objects can differ in length, in diameter, in wall thickness, whether insulation is present, in type of insulation, in amount of insulation, in number of wires, in type of wire, in type of braiding and/or winding, in what is transmissible (for non-limiting example, power, current, voltage, data) in power transmissible, in current transmissible, in voltage transmissible, in type of fluid transmissible, and in pressure. Reasonable combinations of the above are also possible.

The size of the drum will depend on the material to be reeled. Two drums in a device can be the same size or different sizes. Drums can differ in thickness (face-to-face distance). Drum faces can differ in diameter and in thickness. Drum cores can differ in diameter.

The drum must have sufficient volume, outside the drum core, for all of the cable or hose to sit stably on the drum when all of the cable or hose is fully reeled. Preferably, the volume of the drum, outside the drum core, is larger than the volume of the fully-reeled cable or hose.

The drum core can have a circular cross-section or a polygonal cross-section. A polygonal cross-section can have between 3 and 20 sides, preferably 6 or 8.

A drum face can be circular or polygonal. The polygon can have between 3 and 20 sides, preferably 6 or 8.

In different devices, the axles can differ in length and in diameter. Axles can differ in wall thickness.

A device can comprise a plastic, a metal and any combination thereof. Preferably, a drum and the central body are substantially rigid, although a drum and/or a central body can comprise flexible padding and a central body supporting member can be hingedly or otherwise movably attached to a central body.

A plastic can comprise any rigid plastic.

A metal can comprise iron, aluminum, nickel, titanium, copper and any alloy thereof.

This listing of claims represents the current version of claims before the Office:

1. An extension cable reel comprising:
a central body (1) having a first face on a first side of said central body (1) and a second face, on a second side of said central body (1), said second face being on an opposite side of said central body (1) from said first face; and
at least one first predetermined length of electrical cable (6) in electrical communication with at least one second predetermined length of electrical cable (6) via said central body (1);
wherein
said central body (1) has an axle (11) extending perpendicular to a main plane of said central body (1), said axle (11) extending outward from said first face of said central body (1) and extending outward from said second face of said central body (1);
a first drum (2A, 2B), freely rotatably mounted on said axle (11) on said first side, said first drum (2A, 2B) having a first drum internal face (2B) adjacent to said first face of said central body (1) and a first drum external face (2A) opposite to said first drum internal face (2B);
a second drum (2A, 2B), freely rotatably mounted on said axle (11) on said second side, said second drum (2A, 2B) having a second drum internal face (2B) adjacent to said second face and a second drum external face (2A) opposite to said second drum internal face (2B);
said at least one first predetermined length of electrical cable (6) having a first proximal end attached to said first drum (2A, 2B) and a first distal end in electrical communication with at least one plug (5), said first proximal end in electrical communication with said central body (1), said at least one first predetermined length of electrical cable (6) being reversibly windable on said first drum; and
said at least one second predetermined length of electrical cable (6) having a second proximal end attached to said second drum (2A, 2B) and a second distal end in electrical communication with at least one electrical socket (4), said second proximal end in electrical communication with said central body (1), said at least one second predetermined length of electrical cable (6) being reversibly windable on said second drum; and
wherein each current-conducting wire of said at least one first predetermined length of electrical cable (6) is in electrical communication with a current conducting wire of said at least one second predetermined length of electrical cable (6) via at least one first slip ring (13, 14, 15) on said internal face of said first drum (2A, 2B) and at least one second slip ring (13, 14, 15) on said internal face of said second drum (2A, 2B), each of said at least one first slip ring (13, 14, 15) and said at least one second slip ring (13, 14, 15) in electrical communication via at least one two-way contact spring (12) passing through and supported by said central body (1).

2. (canceled)

3. The extension cable reel of claim 1, wherein said central body (1) comprises a supporting member selected from a group consisting of a leg, a carrying handle, a mounting bracket and any combination thereof.

4. The extension cable reel of claim 1, additionally comprising a member of a group consisting of a first non-rotating external face (20), a second non-rotating external face (20) and any combination thereof, said first non-rotating external face (20) being in mechanical communication with said central body (1) on said first side and said second non-rotating external face (20) being in mechanical communication with said central body (1) on said second side.

5. The extension cable reel of claim 1, additionally comprising an accessory selected from a group consisting of an electrical socket (4), a lithium battery charging socket (17), a 5V USB battery charging socket (10), a charging socket for other rechargeable batteries, a reset switch (9), a winding handle (3), a power-on light (16) and any combination thereof.

6. The extension cable reel of claim 5, wherein said accessory is in mechanical communication with a member of a group consisting of said first drum external face (2A), said second drum external face (2A), said first non-rotating external face (20) and said second non-rotating external face (20).

7. The extension cable reel of claim 1, wherein at least one of a group consisting of said first drum (2A, 2B) and said second drum (2A, 2B) comprises a cable end holder (7).

8. The extension cable reel of claim 1, wherein at least one of a group consisting of said first drum (2A, 2B) and said second drum (2A, 2B) comprises a cable rewinding mechanism.

9. The extension cable reel of claim 8, wherein said cable rewinding mechanism comprises at least one spring.

10. The extension cable reel of claim 8, additionally comprising at least one cable rewind stop.

11. The extension cable reel of claim 1, wherein said axle (11) comprises a plurality of drums (2A, 2B) on at least one side, at least one predetermined length of drum electrical cable (6) mounted on each of said plurality of drums (2A, 2B).

12. The extension cable reel of claim 11, wherein each predetermined length of drum electrical cable (6) is in electrical communication with said at least one plug (5) via at least one slip ring (13, 14, 15) and a member of a group consisting of a two-way contact spring (12), a coil spring, a spiral spring, a leaf spring, a brush and any combination thereof.

13. The extension cable reel of claim 1, wherein at least one member of a group comprising said first drum (2A, 2B), said second drum (2A, 2B), and said plurality of drums (2A, 2B) comprises at least two predetermined lengths of electrical cable (6).

14. An extension cable reel comprising:
a central body (1) having a first face on a first side of said central body (1) and a second face on a second side of said central body (1), said second face being on an opposite side of said central body (1) from said first face;
an axle (11) extending perpendicular to a main plane of said central body (1), said axle (11) extending outward from said first face of said central body (1) and extending outward from said second face of said central body (1);
a first drum (2A, 2B), freely rotatably mounted on said axle (11) on said first side, said first drum (2A, 2B) having a first drum internal face (2B) adjacent to said first face of said central body (1) and a first drum external face (2A) opposite to said first drum internal face (2B);
a second drum (2A, 2B), freely rotatably mounted on said axle (11) on said second side, said second drum (2A, 2B) having a second drum internal face (2B) adjacent to said second face and a second drum external face (2A) opposite to said second drum internal face (2B);
at least one first predetermined length of electrical cable (6) having a proximal end attached to said first drum (2A, 2B), said at least one first predetermined length of electrical cable (6) having a first distal end in electrical communication with at least one plug (5), said first proximal end in electrical communication with said central body (1), said at least one first predetermined length of electrical cable (6) being reversibly windable on said first drum; and
at least one second predetermined length of electrical cable (6) having a proximal end attached to said second drum (2A, 2B), said at least one second predetermined length of electrical cable (6) having a second distal end in electrical communication with at least one electrical socket (4), said second proximal end in electrical communication with said central body (1), said at least one second predetermined length of electrical cable (6) being reversibly windable on said second drum;
wherein said at least one first predetermined length of electrical cable (6) is in electrical communication with said at least one second predetermined length of electrical cable (6); and
wherein each current-conducting wire of said at least one first predetermined length of electrical cable (6) is in electrical communication with a current conducting wire of said at least one second predetermined length of electrical cable (6) via at least one first slip ring (13, 14, 15) on said internal face of said first drum (2A, 2B) and at least one second slip ring (13, 14, 15) on said internal face of said second drum (2A, 2B), each of said at least one first slip ring (13, 14, 15) and said at least one second slip ring (13, 14, 15) in electrical communication via at least one two-way contact spring (12) passing through and supported by said central body (1).

15. (canceled)

16. The extension cable reel of claim 14, wherein said central body (1) comprises a supporting member selected from a group consisting of a leg, a carrying handle, a mounting bracket and any combination thereof.

17. The extension cable reel of claim 14, additionally comprising a member of a group consisting of a first non-rotating external face (20), a second non-rotating external face (20) and any combination thereof, said first non-rotating external face (20) being in mechanical communication with said central body (1) on said first side and said second non-rotating external face (20) being in mechanical communication with said central body (1) on said second side.

18. The extension cable reel of claim 14, additionally comprising an accessory selected from a group consisting of an electrical socket (8), a lithium battery charging socket (17), a 5V USB battery charging socket (10), a charging socket for other rechargeable batteries, a reset switch (9), a winding handle (3), a power-on light (16) and any combination thereof.

19. The extension cable reel of claim 18, wherein said accessory is in mechanical communication with a member of a group consisting of said first drum external face (2A), said second drum external face (2A), said first non-rotating external face (20) and said second non-rotating external face (20).

20. The extension cable reel of claim 14, wherein at least one of a group consisting of said first drum (2A, 2B) and said second drum (2A, 2B) comprises a cable end holder (7).

21. The extension cable reel of claim 14, wherein at least one of a group consisting of said first drum (2A, 2B) and said second drum (2A, 2B) comprises a cable rewinding mechanism.

22. (canceled)

23. (canceled)

24. (canceled)

25. (canceled)

26. (canceled)

27. A method of generating an extension cable reel, comprising steps of:
providing a central body (1) having a first face on a first side of said central body (1) and a second face on a second side of said central body (1), said second face being on an opposite side of said central body (1) from said first face; and
providing at least one first predetermined length of electrical cable (6) in electrical communication with at least one second predetermined length of electrical cable (6) via said central body (1);
wherein said method additionally comprises steps of:
extending an axle (11) from said central body (1), said axle (11) extending perpendicular to a main plane of said central body (1), said axle (11) extending outward from said first face of said central body (1) and extending outward from said second face of said central body (1);
freely rotatably mounting a first drum (2A, 2B) on said axle (11) on said first side, said first drum (2A, 2B) having a first drum internal face (2B) adjacent to said first face of said central body (1) and a first drum external face (2A) opposite to said first drum internal face (2B);
attaching a first proximal end of said at least one first predetermined length of electrical cable (6) to said first drum (2A, 2B), said first proximal end in electrical communication with said central body (1);
placing at least one plug (5) in electrical communication with a first distal end of said at least one first predetermined length of electrical cable (6);
reversibly winding said at least one first predetermined length of electrical cable (6) on said first drum;
freely rotatably mounting a second drum (2A, 2B) on said axle (11) on said second side, said second drum (2A, 2B) having a second drum internal face (2B) adjacent to said second face and a second drum external face (2A) opposite to said second drum internal face (2B);
attaching a second proximal end of said at least one second predetermined length of electrical cable (6) to said second drum (2A, 2B), said second proximal end in electrical communication with said central body (1);
placing at least at least one electrical socket (4) in electrical communication with a second distal end of said at least one second predetermined length of electrical cable; and
reversibly winding said at least one second predetermined length of electrical cable (6) on said second drum; and
wherein said method additionally comprising
a step of providing, for each current-conducting wire of said at least one first predetermined length of electrical cable (6) is in electrical communication with a current conducting wire of said at least one second predetermined length of electrical cable (6) via at least one first slip ring (13, 14, 15) on said internal face of said first drum (2A, 2B) and at least one second slip ring (13, 14, 15) on said internal face of said second drum (2A, 2B), each of said at least one first slip ring (13, 14, 15) and said at least one second slip ring (13, 14, 15) in electrical communication via at least one two-way contact spring (12) passing through and supported by said central body (1).

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. (canceled)

40. (canceled)

41. (canceled)

42. (canceled)
